(19) United States
(12) Patent Application Publication
(10) Pub. No.: US 2023/0331458 A1
(43) Pub. Date: Oct. 19, 2023

(54) REUSABLE COOKING BAG

(71) Applicant: Anova Applied Electronics, Inc., San Francisco, CA (US)

(72) Inventor: Harrison John Lees, San Francisco, CA (US)

(73) Assignee: Anova Applied Electronics, Inc., San Francisco, CA (US)

(21) Appl. No.: 18/027,228

(22) PCT Filed: Aug. 31, 2021
(86) PCT No.: PCT/US2021/048329

§ 371 Date: Mar. 20, 2023

Related U.S. Application Data
(60) Provisional application No. 63/081,566, filed on Sep. 22, 2020.

(51) Int. Cl. B65D 81/34; B65D 33/16

(52) U.S. Cl. CPC B65D 81/3415; B65D 33/1616

(57) ABSTRACT

A reusable cooking bag having first and second panels joined at a perimeter seam to form a cavity between the first panel and the second panel, and at least one preformed folding seam comprising a line of reduced thickness of at least one of the first panel and the second panel. The least one folding seam extends along a direction of the opening and is spaced from the opening to provide a discrete location at which the first panel and the second panel can be folded.

### CROSS-REFERENCE TO RELATED APPLICATIONS

This application claims priority to U.S. Provisional Patent Application No. 63/081,566, filed on Sep. 22, 2020, titled “REUSABLE COOKING BAG,” the entirety of which is incorporated by reference herein.

### BACKGROUND

Sous vide cooking is becoming a popular method for preparing foods. Sous vide cooking uses a heated liquid bath to cook the food. In typical cases, a water bath is raised to the desired heating temperature using a partially submerged heating unit or by circulating heated water from a remote heater into the bath. The food is placed into a sealed bag, and the bag and food are placed into the water bath. Heat transfer occurs from the water to the food through the intervening bag. The bag is desirable to prevent water from contacting the food, in order to preserve nutrients and flavor, and prevent the food from changing to an undesirable form by contact with the water.

Typical sous vide bags include conventional sealable plastic bags that are used for general food storage, and vacuum-sealed bags. Regardless of the type of bag, it is usually desirable to extract as much air as possible from the bag, to provide the greatest possible heat transfer from the bath to the food. Large air bubbles can prevent regions of the food from cooking evenly. In vacuum-sealed bags, air is extracted by a vacuum pump, and the bag is then sealed closed using heat to melt the bag to itself, or using adhesives or the like. Conventional sealable bags require the user to manually extract as much air as possible, which can be difficult if the food has a complex shape.

It is also known to use silicone containers to hold food in a sous vide water bath. For example, Spanish patent application ES 2323344 A1 describes a silicone container for cooking food. Silicone containers can be washed and reused, and offer long-term cost savings. However, it can be difficult to extract air from known silicone containers due to their relative stiffness as compared to the aforementioned alternatives, and the fact that the silicone may need to be elastically deformed to match the contours of the food, resulting in an elastic restoring force that tends to pull the bag back to its original shape. For instance, the aforementioned Spanish patent application ES 2323344 A1 has pre-formed corners at which the container can be folded over, but the restoring forces generated upon deforming the container would tend to pull it into an open shape. Furthermore, known silicone containers also have relatively weak closures, and can open under heavy loading that might not be a problem for a conventional sealable bag or vacuum-sealed bag.

The inventors have determined that the state of the art of reusable cooking bags can be improved.

### SUMMARY

In a first exemplary aspect, there is provided a reusable cooking bag having: a first panel having an outer first panel face and an inner first panel face; a second panel having an outer second panel face and an inner second panel face; a perimeter seam joining the first panel to the second panel with the inner first panel face facing the inner second panel face, to form a cavity between the first panel and the second panel, the cavity extending from a closed bag end to an open bag end; an opening formed between the first panel and the second panel at the open bag end, the opening comprising a region in which the first panel is not permanently joined to the second panel; and at least one preformed folding seam comprising a line of reduced thickness of at least one of the first panel and the second panel, the at least one folding seam extending along a direction of the opening and spaced from the opening to provide a discrete location at which the first panel and the second panel can be folded.

In some exemplary embodiments, the at least one folding seam comprises a line of reduced thickness of both the first panel and the second panel.

In some exemplary embodiments, the at least one folding seam comprises a first folding seam located at a first distance from the opening and a second folding seam located at a second distance from the opening.

In some exemplary embodiments, the second distance is at least two times greater than the first distance.

In some exemplary embodiments, the second distance is less than or equal to 25% of a distance between the open bag end and the closed bag end.

In some exemplary embodiments, the at least one folding seam comprises a first folding seam located at a first distance from the opening, a second folding seam located at a second distance from the opening, and a third seam located at a third distance from the opening.

In some exemplary embodiments, the second distance is at least two times greater than the first distance, and the third distance is at least three times greater than the first distance.

In some exemplary embodiments, the third distance is less than or equal to 25% of a distance between the open bag end and the closed bag end.

In some exemplary embodiments, the at least one folding seam extends along a straight line parallel to the opening direction.

In some exemplary embodiments, the at least one folding seam extends an entire distance from a first point along the perimeter seam to a second point along the perimeter seam.

In some exemplary embodiments, the at least one folding seam comprises a first groove formed in the outer first panel face and a second groove formed in the outer second panel face.

In some exemplary embodiments, the first panel comprises a first lip comprising a respective region of increased thickness adjacent to the opening, and the second panel comprises a second lip comprising a respective region of increased thickness adjacent to the opening, and wherein the first lip and the second lip are between the at least one folding seam and the opening and spaced from the at least one folding seam.

In some exemplary embodiments, the bag further comprising a strap extending from the perimeter seam adjacent a first end of the opening and a clasp extending from the perimeter seam adjacent a second end of the opening, the strap being configured to selectively secure to the clasp.

In some exemplary embodiments, the clasp comprises a hole, and the strap extends along a longitudinal axis and comprises at least one lateral protrusion extending away from the longitudinal axis, the at least one lateral protrusion being larger in at least one dimension than the hole, such that at least one of the lateral protrusion and the hole must elastically deform to allow the lateral protrusion to pass through the hole.

In some exemplary embodiments, the at least one lateral protrusion comprises a plurality of lateral protrusions located along the longitudinal axis.

In some exemplary embodiments, the bag further comprises: at least one first interference rib extending from the inner first panel face towards the inner second panel face, each at least one first interference rib extending along the opening and spaced from the opening by a respective first rib distance; and at least one second interference rib extending from the inner second panel face towards the inner first panel face, each at least one second interference rib extending along the opening and spaced from the opening by a respective second rib distance; wherein the respective second rib distance of each second rib is not the same as the respective first rib distance of any of the at least one first interference ribs, such that the at least one first rib and the at least one second rib form a tortuous path when the inner first panel face abuts the inner second panel face.

In some exemplary embodiments, at least one of the first panel and the second panel comprises a transparent region and a non-transparent region.

In some exemplary embodiments, the non-transparent region comprises a translucent region or an opaque region.

In some exemplary embodiments, the transparent region is spaced from the perimeter seam, and the non-transparent region surrounds the transparent region.

In some exemplary embodiments, the transparent region and the non-transparent region comprise two different regions of a single unitary structure.

In some exemplary embodiments, the first panel joins the second panel at the perimeter seam at an acute angle when the cooking bag is in an undeformed configuration.

In some exemplary embodiments, the entirety of the reusable cooking bag comprises a single molded silicone part.

In some exemplary embodiments, the first panel and the second panel each comprises a single unitary layer of material.

In some exemplary embodiments, the first panel and the second panel each comprises a silicone material having a nominal thickness of 1 millimeter or less.

In some exemplary embodiments, the first panel and the second panel each comprises a silicone material having a nominal thickness of 0.75 millimeters or less.

In another exemplary aspect, there is provided a reusable cooking bag having: a first panel having an outer first panel face and an inner first panel face; a second panel having an outer second panel face and an inner second panel face; a perimeter seam joining the first panel to the second panel with the inner first panel face facing the inner second panel face, to form a cavity between the first panel and the second panel, the cavity extending from a closed bag end to an open bag end; an opening formed between the first panel and the second panel at the open bag end, the opening comprising a region in which the first panel is not permanently joined to the second panel; a strap extending from the perimeter seam adjacent a first end of the opening; and a clasp extending from the perimeter seam adjacent a second end of the opening, the strap being configured to selectively secure to the clasp. The clasp comprises a hole, and the strap extends along a longitudinal axis and comprises at least one lateral protrusion extending away from the longitudinal axis, the at least one lateral protrusion being larger in at least one dimension than the hole, such that at least one of the lateral protrusion and the hole must elastically deform to allow the lateral protrusion to pass through the hole.

In some exemplary aspects, the at least one lateral protrusion comprises a plurality of lateral protrusions located along the longitudinal axis.

In some exemplary aspects, the first panel, second panel, seam, strap and clasp are comprise a single molded part.

In some exemplary aspects, the single molded part comprises a silicone material.

In some exemplary aspects, the reusable cooking bag further includes at least one preformed folding seam comprising a line of reduced thickness of at least one of the first panel and the second panel, the at least one folding seam extending along a direction of the opening and spaced from the opening to provide a discrete location at which the first panel and the second panel can be folded.

### BRIEF DESCRIPTION OF THE DRAWINGS

Examples of various inventions described herein are illustrated in the following drawings, in which like reference numbers refer to like parts.

FIG. 1 is a front perspective view of a reusable cooking bag according to a first exemplary embodiment.

FIG. 2 is a rear perspective view of the reusable cooking bag of FIG. 1.

FIG. 3 is a cutaway side view of the reusable cooking bag of FIG. 1.

FIG. 4 is a partial perspective view of another embodiment of a reusable cooking bag.

FIGS. 5A-5C are partial schematic section side views of embodiments of different reusable cooking bag folding seams.

FIG. 6 is a partial top plan view of the cooking bag of FIG. 1 showing a strap engaging a schematically-illustrated clasp.

FIGS. 7A-7C schematically illustrate alternative strap engagement structures.

FIG. 8 is a partial cutaway perspective view of another embodiment of a reusable cooking bag showing the opening region thereof.

### DETAILED DESCRIPTION OF EXEMPLARY EMBODIMENTS

It has been determined that various deficiencies of existing reusable cooking bags can be addressed or mitigated by providing a reusable bag having various features as described by example herein. Such features may be used separately or in combination, and may be modified depending on the particular application, bag size, intended food, and so on. Thus, the embodiments herein will be understood to be non-limiting examples of the inventions disclosed and claimed herein.

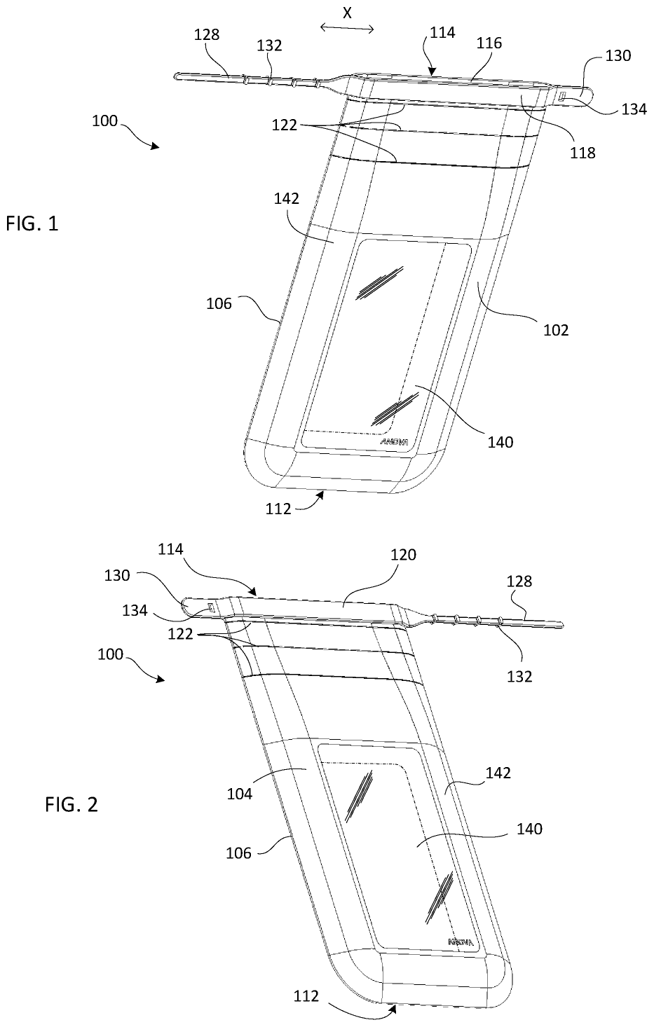

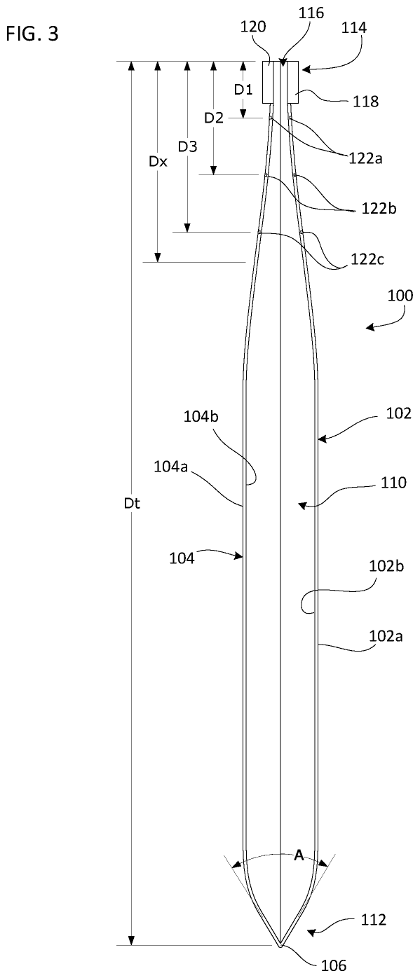

Embodiments will now be discussed in relation to the attached figures. FIGS. 1 and 2 show front and rear views of a reusable flexible cooking bag 100 having a first panel 102 and a second panel 104. FIG. 3 shows the same bag 100 in cross section. The bag 100 preferably is constructed as a single molded part, but alternatively it may be assembled from separate parts that are connected together using adhesives, ultrasonic bonding, heat sealing, overmolding, fasteners, and so on. The bag 100 preferably comprises a silicone composition, but other food-safe flexible materials may be used.

The first panel 102 has an outer first panel face 102a, and an inner first panel face 102b. Likewise, the second panel 104 has an outer second panel face 104a and an inner second panel face 104b. A perimeter seam 106 joins the first panel 102 to the second panel 104, with the inner first panel face 102b facing the inner second panel face 104b. Thus, as shown in FIG. 3, a cavity 110 is formed between the first panel 102 and the second panel 104. The cavity 110 extends from a closed bag end 112 to an open bag end 114.

The first panel and the second panel each is preferably made as a single unitary layer of material (e.g., a single sheet of silicone without an interior or exterior lining). This simplifies construction, can increase heat transfer through the panels 102, 104, and prevents the formation of air bubbles between layers that might impede heat transfer. The first panel 102 and second panel 104 preferably are generally flat, such that the first and second panels 102, 104 comprise large planar regions that face each other, and are closely spaced but not touching when the bag 100 is in an undeformed condition. As used herein, the undeformed condition is the state in which the bag 100 rests with a minimum of internal stresses. This generally corresponds to the mold shape for a molded product, and can be simulated by suspending the bag 100 in a medium (e.g., water) with the medium allowed to enter the cavity 110 and equalize in pressure with the uncontained medium outside the bag 100. Providing a space between the panels 102, 104 when the bag 100 is undeformed helps prevent the respective inner panel surfaces 102b, 104b from contacting each other when it is desired to dry the cavity 110, and helps a user manipulate food into and out of the bag 100.

The perimeter seam 106 may be configured to help the bag 100 obtain a space between the panels 102, 104, while still allowing the bag 100 to be flattened to extract air in preparation for cooking. For example, the perimeter seam 106 may be shaped to connect the first panel 102 to the second panel 104 at an acute angle A (FIG. 3) when the cooking bag is in an undeformed configuration. For example, the first panel 102 and second panel 104 may turn towards each other at the perimeter seam 106 to join at an angle A of about 90 degrees to 30 degrees (total included angle), and more preferably about 60 degrees. Such embodiments are expected to help spread the first panel 102 and second panel apart 104 when the bag 100 is in a relaxed state, but be easy to flatten with little or no captured air. In the shown example, the angle A is defined by equally bent portions of each panel 102, 104 (e.g., each panel 102, 104 is bent towards the other by about 30 degrees), but in other cases the panels 102, 104 may not be bent equally. For example, the first panel 102 may be entirely flat, and the second panel 104 may bend towards the first panel 102 at an angle of 60 degrees to form the angled perimeter seam 106. Other alternatives and variations will be apparent to persons of ordinary skill in the art in view of the present disclosure.

An opening 116 is formed between the first panel 102 and the second panel 104 at the open bag end 114. The opening 116 is a region in which the first panel 102 is not permanently joined to the second panel 104. For example, the opening 116 may be formed by terminal edges of the first panel 102 and second panel 104 where the edges are not joined to each other by the perimeter seam 106. The opening 116 may be formed, for example, by cutting a portion of the perimeter seam 106, or by not creating the perimeter seam 106 in the first instance.

The perimeter of the opening 116 may be conveniently defined by edges of the first panel 102 and the second panel 104. The first panel 102 may terminate at a first lip 118 comprising a region of increased thickness adjacent to the opening 116, and the second panel 104 may terminate at a second lip 120 comprising a region of increased thickness adjacent to the opening 116. As used herein, a region of increased thickness will be understood to be a region in which the wall thickness of the panel 102, 104 increases relative to the immediately adjacent region. As shown in FIGS. 1-3, the lips 118, 120 may extend the full width of the bag 100 to join two points of the perimeter seam 106. However, this is not strictly required. The lips 118, 120 are expected to provide improved durability, and make it easier to hold the opening 116 in an open position (e.g., by squeezing the two points of the perimeter seam 106 towards each other) to receive food. The lips 118, 120 are also expected to help the opening 116 retain its shape as food is being inserted into the bag 100. In one embodiment, the lips 118, 120 may have a thickness that is at least 3 times, and more preferably about 5 times, the thickness of the adjacent portions of the panels 102, 104.

The shown lips 118, 120 are formed monolithically with the rest of the bag 100. For example, the lips 118, 120 may be injection molded with the remainder of the bag 100. In alternative embodiments, the lips 118, 120 may be removed, or they may be formed by separate parts. For example, the lips 118, 120 may be formed by plastic regions that are overmolded along the edges of the first panel 102 and second panel 104. Other alternatives and variations will be apparent to persons of ordinary skill in the art in view of the present disclosure.

The bag 100 also includes at least one preformed folding seam 122 at which the bag 100 can be folded. Each folding seam 122 comprises a line of reduced thickness of at least one of the first panel 102 and the second panel 104, and more preferably in both the first panel 102 and the second panel 104. As used herein, a line of reduced thickness means an area in which the thickness of the panel 102, 104 is reduced as compared to the immediately adjacent regions on each side of the line. In exemplary embodiments, each folding seam 122 may have a thickness that is about 75% or less, and more preferably about 60% or less, than the thickness of the adjacent portions of the panels 102, 104.

The folding seams 122 extend along a direction X of the opening 116. The opening direction X is a direction defined by a line extending from the points at which the opening intersects the perimeter seam 106. The term “extend along” is understood to mean a direction that is more aligned with the direction than not. For example, the folding seams 122 may extend along the opening direction X by being parallel to the opening direction X, as shown in FIGS. 1 and 2. In other embodiments, the folding seams 122 may extend along the opening direction X, but not be parallel to it. For example, the folding seams 122 may be angled up to 45° from the opening direction X while still extending along it.

Each folding seam 122 provides a discrete location at which the first panel 102 and the second panel 104 can be folded. In particular, it will be understood that the reduced thickness of the panel 102, 104 will create a hinge-like line at which bending forces generate a greater deflection than the adjacent thicker regions. Thus, a bending load applied to the open end 116 will cause the bag 100 to fold more distinctly at the folding seams 122 than in the surrounding regions.

A single folding seam 122 is expected to provide benefits as discussed below. However, embodiments, also may have two, three, or more folding seams 122. Each folding seam 122 may be identical to the others, but this is not strictly required. For example, one folding seam 122 may comprise a line of reduced thickness in only the first panel 102, and a second folding seam 122 may comprise a line of reduced thickness in only the second panel 104.

Each folding seam 122 is located at a respective distance from the opening 116. For example, as shown in FIG. 3, the bag 100 may have a first folding seam 122a located at a first distance D1 from the opening 116, a second folding seam 122b located at a second distance D2 from the opening 116, and a third folding seam 122c located at a third distance D3 from the opening 116, with the second distance D2 being greater than the first distance D1, and the third distance D3 being greater than the second distance D2. The distances D1, D2, D3 can be selected as desired to provide different folding locations, but at least one of the distances D1, D2, D3 is preferably selected to be between the opening 116 and the location in which food is stored within the bag 100 during cooking. For example, the third distance D3 may be midway between the closed end 112 and the open end 114, to provide a location at which the user can fold the bag 100 to use approximately half of the internal volume of the bag 100. The distances D1, D2, D3 may also be selected to be used cooperatively. For example, the second distance D2 may be at least two times greater than the first distance D1, and the third distance D3 may be at least three times greater than the first distance D1, such that the user can create a separate discrete fold at each folding seam 122 by rolling the open end 114 down towards the closed end 112. The spacing of the folding seams 122 also may be selected based on the shape the bag 100 takes as the open end 114 is being rolled towards the closed end 112. For example, the folding seams 122 may be spaced with sufficient distance that each folding seam 122 can be folded even when the upper portions of the bag are folded onto themselves. Also, if the bag 100 has lips 118, 120, the lips 118, 120 preferably are located between the folding seams 122 and the opening 116 so as to not interfere with folding the bag 100.

While folding seams 122 may be located essentially anywhere on the bag 100, the shown exemplary bag 100 has all of the folding seams 122 located, relative to the opening 116, within a distance Dx that is less than or equal to 25% of a distance Dt between the open bag end 114 and the closed bag end 112. In this embodiment, the bag 100 comprises a relatively large storage region, and a relatively small folding region between the storage region and the opening 116. It is expected that this configuration will be convenient for a variety of cooking applications, and intuitive to use.

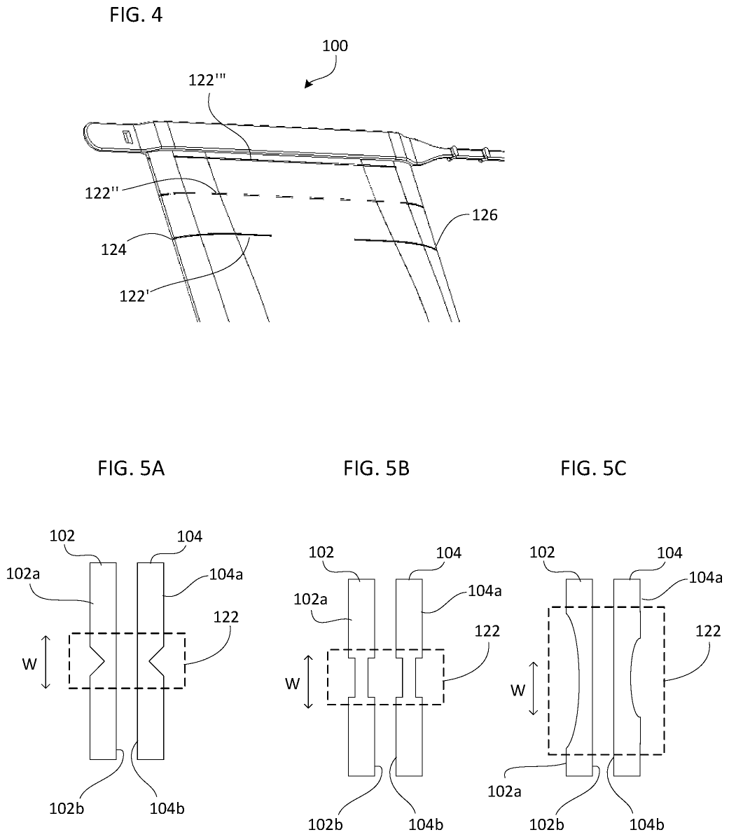

Each folding seam 122 may extend an entire distance from a first point along the perimeter seam 106 to a second point along the perimeter seam 106, such as shown in FIGS. 1 and 2. However, this is not strictly required. In other cases, one or more of the folding seams 122 may extend only partially between two points on the perimeter seam 106, or comprise a pattern of locations between two such points. FIG. 4 shows three examples of alternatives. A first folding seam 122′ is interrupted midway between a first point 124 along the perimeter seam 106 and a second point 126 along the perimeter seam 106. A second folding seam 122″ comprises a pattern of areas of reduced thickness that stretch along a line between points along the perimeter seam 106. A third folding seam 122′″ extends between respective points along the perimeter seam 106, but does not extend to the perimeter seam 106, which may be helpful to avoid creating stress risers at the perimeter seam 106. Other alternatives and variations will be apparent to persons of ordinary skill in the art in view of the present disclosure.

The folding seams 122 may have any suitable cross-sectional profile (i.e., profile as viewed along the folding seam 122). FIGS. 5A through 5C illustrate three examples. In FIG. 5A, the folding seam 122 has a triangular shape located on the respective outer panel face 102a, 104a of each panel 102, 104. Placing the lines of reduced thickness only on the outer panel faces 102a, 104a is expected to make cleaning of the bag 100 easier because food and liquids cannot be trapped in these regions inside the bag 100. The use of discrete lines of reduced thickness that are easily visible to the user, such as the shown triangular shapes, is also expected to make it easier to determine where to fold the bag 100, leading to more intuitive and easier use. This is also expected to be easier to form using certain molding techniques, due to the smooth inner surfaces 102b, 104b facilitating removal from the mold.

In FIG. 5B, the folding seam 122 has a rectangular shape on both faces 102a, 102b, 104a, 104b of each panel 102, 104. Forming the region of reduced thickness in both the outer face 102a, 104a and the inner face 102b, 104b may be advantageous for providing increased flexibility and avoiding stress risers, but may be more difficult to form.

In FIG. 5C, the folding seam has an ovate shape on the respective outer panel face 102a, 104a of each panel 102, 104, with the region of reduced thickness on the first panel 102 being larger in cross-section than the region of reduced thickness on the second panel 104. Embodiments with different shapes of the lines of reduced thickness on the two panels 102, 104 may be advantageous to increase flexibility at the folding seam 122, by making it easier to fold one panel over the other in a particular direction (i.e., folding the larger folding seam 122 over the smaller folding seam 122).

The folding seams 122 may have any suitable width dimension W, as measured perpendicular to the direction of the line of reduced thickness. For example, where the panels 102, 104 each comprise 0.75 millimeter (0.03 inch) thick silicone, the width W may be approximately 0.50 millimeters (0.02 inches) or less. In a preferred embodiment, the width dimension is wider than the depth of the reduction in thickness. In addition, FIGS. 5A-5C show the reduction in thickness being positioned between (in the width direction W) two adjacent regions of the panel 102, 104 that have the same thickness. While this is preferred, it is not strictly required. For example, in other embodiments, the panel 102, 104 may have a first thickness on one side of the folding seam 122, and a second thickness on the other side of the folding seam 122, with the first and second thicknesses being different.

It will be appreciated from the foregoing and through routine experimentation that the shapes and sizes of the lines of reduced thickness forming the folding seams 122 may be varied to achieve a variety of different objectives. Other alternatives and variations will be apparent to persons of ordinary skill in the art in view of the present disclosure.

The bag 100 may be provided with any suitable mechanism to hold the bag 100 in a closed position after it is folded along the folding seam(s) 122. In one embodiment, the bag 100 may include a strap 128 that extends from the perimeter seam 106 adjacent a first end of the opening 116 and a clasp 130 that extends from the perimeter seam 106 adjacent a second end of the opening 116. The strap 128 and clasp 130 may extend from one or both lips 118, 120 if such are provided, or they may extend directly from one or both panels 102, 104. The strap 128 and clasp 130 are configured to selectively secure to each other, and may include any suitable connector mechanism, such as a buckles, hook and loop fasteners, and so on.

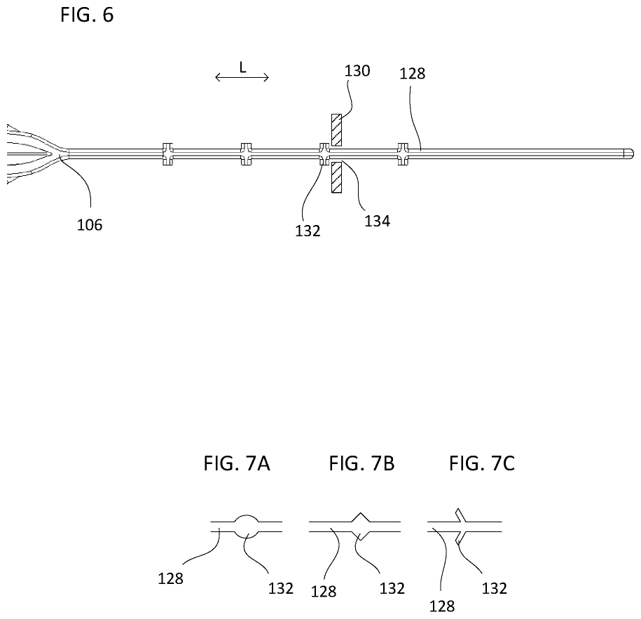

Referring now to FIG. 6, in one exemplary embodiment, the strap 128 is configured to fit into the clasp 130 using an interference fit. The strap 128 extends along a longitudinal axis L and has one or more lateral protrusions 132 extending away from the longitudinal axis L. The clasp 130 has a hole 134 into which the strap 128 fits, and the lateral protrusions 132 are larger, in at least one dimension, than the hole 134. For example, the lateral protrusions 132 may be larger in a plane perpendicular to the longitudinal direction L than the hole 134. Thus, either the lateral protrusions 132 or the hole 134 must deform to allow the lateral protrusions 132 through the hole 134. This embodiment provides an interference fit system that can be secured and released simply by applying sufficient force to deform the parts, and when the parts are made of silicone or other similar material such deformation can be readily performed by the user. Furthermore, by providing multiple lateral protrusions 132 along the longitudinal axis L, the mechanism may be adjusted to various securement positions depending on the circumstances.

It will be appreciated that the hole 134 and lateral protrusions 132 may have any suitable shapes. In FIG. 6, the lateral protrusions 132 are rectangular. FIGS. 7A through 7C show exemplary alternative shapes. In FIG. 7A, the lateral protrusions 132 are rounded (spherical, oval, egg-shaped, etc.). In FIG. 7B, the lateral protrusions 132 are rectilinear (triangular, etc.). In FIG. 7C, the lateral protrusions 132 are barb shaped, which can result in different amounts of force being necessary to engage and disengage the lateral protrusions 132 with the hole 134. Other alternatives and variations will be apparent to persons of ordinary skill in the art in view of the present disclosure.

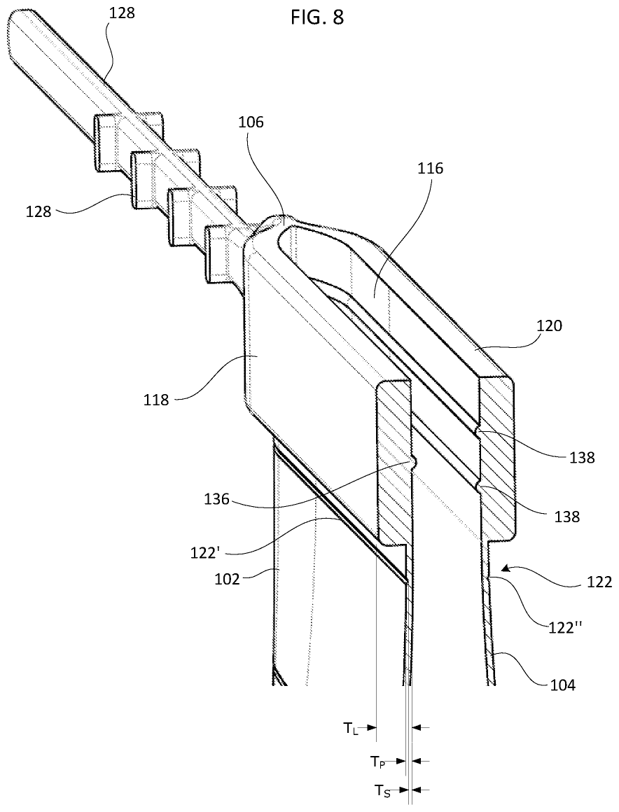

The bag 100 also may include other features to help improve sealing. For example, the first panel 102 and second panel 104 may have internal parts or structures that interact to inhibit fluid motion. In FIG. 8, one or more first interference ribs 136 extend from the inner first panel face 102b towards the inner second panel face 104b, and one or more second interference ribs 138 extend from the inner second panel face 104b towards the inner first panel face 104a. The interference ribs 136, 138 extend along the opening 116, and are spaced at different distances from the opening 116, such that the first interference ribs 136 overlap in a direction towards the opening 116 and form a tortuous path when the inner first panel face 102b abuts the inner second panel face 104b.

FIG. 8 also illustrates features of the lips 118, 120 (when present) and one folding seam 122 in more detail. Specifically, the lips 118, 120 comprise respective regions of increased thickness, in which the wall thickness T_{L} of each panel 102, 104 increases relative to the wall thickness T_{P} of the immediately adjacent regions of the respective panel 102, 104. Similarly, the folding seam 122 comprises lines of reduced thickness 122′, 122″ in each panel 102, 104, having a thickness T_{S} that is reduced as compared to the thickness T_{L} of each panel 102, 104 in the immediately adjacent regions on each side of the lines of reduced thickness 122′, 122″. Also, FIG. 8 shows the lips 112, 120 are spaced from the nearest folding seam 122 by a gap, in which the panels 102, 104 have their nominal wall thickness T_{P}.

Referring back to FIGS. 1 and 2, the bag 100 also may include features to make its use more efficient and simple. For example, the bag 100 may include one or more transparent regions 140 through which the contents of the bag 100 can be clearly visualized. In this example, each panel 102, 104 has a transparent region 140 and a non-transparent region 142 that surrounds the transparent region 140. Each non-transparent region 142 comprises a region in which the bag is either translucent or opaque. The shown non-transparent regions 142 extends the full distance from the transparent region 140 to the seam 106. The transparent regions 140 may be formed integrally with the non-transparent regions 142, such as by molding the bag 100 as a single unitary silicone part, with different surface treatments applied to the transparent region 140 and non-transparent region 142 either in the mold or during post-mold processing.

As explained above, known reusable bags suffer from problems caused by the stiffness of the bag material. For example, typical known silicone sous vide bags are not be flexible enough to reduce the volume of the bag by folding the bag onto itself, and the seams can be opened with relative ease. Embodiments as described herein or otherwise constructed may address one or more of these problems. For example, the bag 100 may be formed of a thin, pliable silicone material, such as food-grade silicone having a nominal thickness of about 1 millimeter (0.04 inches) or less, or more preferably about 0.75 mm (0.03 in) throughout the majority of the first panel 102 and second panel 104. In this example, the bag 100 can be loaded with food, and the air extracted by submerging the bag in water, applying a vacuum, and/or manually manipulating the contents to force the air out. The bag 100 can then be folded at the folding seam(s) 122 to provide distinct folds at which the panels 102, 104 contact each other to provide a liquid seal. Once folded, the bag 100 can be secured using a clip or a built-in fastener such as the illustrated strap 128 and clasp 130, to thus hold the bag 100 in the folded state and secure it for cooking. Bags such as the ones described herein can advantageously be made entirely from a single molded part, using silicone or other similar flexible materials, but other constructions may be used in some embodiments.

The present disclosure describes a number of inventive features and/or combinations of features that may be used alone or in combination with each other or in combination with other technologies. The embodiments described herein are all exemplary, and are not intended to limit the scope of the claims. It will also be appreciated that the inventions described herein can be modified and adapted in various ways, and all such modifications and adaptations are intended to be included in the scope of this disclosure and the appended claims.

1. A reusable cooking bag comprising:
a first panel having an outer first panel face and an inner first panel face;
a second panel having an outer second panel face and an inner second panel face;
a perimeter seam joining the first panel to the second panel with the inner first panel face facing the inner second panel face, to form a cavity between the first panel and the second panel, the cavity extending from a closed bag end to an open bag end;
an opening formed between the first panel and the second panel at the open bag end, the opening comprising a region in which the first panel is not permanently joined to the second panel; and
at least one preformed folding seam comprising a line of reduced thickness of at least one of the first panel and the second panel, the at least one folding seam extending along a direction of the opening and spaced from the opening to provide a discrete location at which the first panel and the second panel can be folded.

2. The reusable cooking bag of claim 1, wherein the at least one folding seam comprises a line of reduced thickness of both the first panel and the second panel.

3. The reusable cooking bag of claim 1, wherein the at least one folding seam comprises a first folding seam located at a first distance from the opening and a second folding seam located at a second distance from the opening.

4. The reusable cooking bag of claim 3, wherein the second distance is at least two times greater than the first distance.

5. (canceled)

6. The reusable cooking bag of claim 1, wherein the at least one folding seam comprises a first folding seam located at a first distance from the opening, a second folding seam located at a second distance from the opening, and a third seam located at a third distance from the opening.

7-10. (canceled)

11. The reusable cooking bag of claim 1, wherein the at least one folding seam comprises a first groove formed in the outer first panel face and a second groove formed in the outer second panel face.

12. The reusable cooking bag of claim 1, wherein the first panel comprises a first lip comprising a respective region of increased thickness adjacent to the opening, and the second panel comprises a second lip comprising a respective region of increased thickness adjacent to the opening, and wherein the first lip and the second lip are between the at least one folding seam and the opening and spaced from the at least one folding seam.

13. The reusable cooking bag of claim 1, further comprising a strap extending from the perimeter seam adjacent a first end of the opening and a clasp extending from the perimeter seam adjacent a second end of the opening, the strap being configured to selectively secure to the clasp.

14. The reusable cooking bag of claim 13, wherein the clasp comprises a hole, and the strap extends along a longitudinal axis and comprises at least one lateral protrusion extending away from the longitudinal axis, the at least one lateral protrusion being larger in at least one dimension than the hole, such that at least one of the lateral protrusion and the hole must elastically deform to allow the lateral protrusion to pass through the hole.

15. (canceled)

16. The reusable cooking bag of claim 1, further comprising:
at least one first interference rib extending from the inner first panel face towards the inner second panel face, each at least one first interference rib extending along the opening and spaced from the opening by a respective first rib distance; and
at least one second interference rib extending from the inner second panel face towards the inner first panel face, each at least one second interference rib extending along the opening and spaced from the opening by a respective second rib distance;
wherein the respective second rib distance of each second rib is not the same as the respective first rib distance of any of the at least one first interference ribs, such that the at least one first rib and the at least one second rib form a tortuous path when the inner first panel face abuts the inner second panel face.

17. The reusable cooking bag of claim 1, wherein at least one of the first panel and the second panel comprises a transparent region and a non-transparent region.

18-19. (canceled)

20. The reusable cooking bag of claim 17, wherein the transparent region and the non-transparent region comprise two different regions of a single unitary structure.

21. The reusable cooking bag of claim 1, wherein the first panel joins the second panel at the perimeter seam at an acute angle when the cooking bag is in an undeformed configuration.

22. The reusable cooking bag of claim 1, wherein the entirety of the reusable cooking bag comprises a single molded silicone part.

23. The reusable cooking bag of claim 1, wherein the first panel and the second panel each comprises a single unitary layer of silicone material.

24-25. (canceled)

26. A reusable cooking bag comprising:
a first panel having an outer first panel face and an inner first panel face;
a second panel having an outer second panel face and an inner second panel face;
a perimeter seam joining the first panel to the second panel with the inner first panel face facing the inner second panel face, to form a cavity between the first panel and the second panel, the cavity extending from a closed bag end to an open bag end;
an opening formed between the first panel and the second panel at the open bag end, the opening comprising a region in which the first panel is not permanently joined to the second panel;
a strap extending from the perimeter seam adjacent a first end of the opening; and
a clasp extending from the perimeter seam adjacent a second end of the opening, the strap being configured to selectively secure to the clasp;
wherein the clasp comprises a hole, and the strap extends along a longitudinal axis and comprises at least one lateral protrusion extending away from the longitudinal axis, the at least one lateral protrusion being larger in at least one dimension than the hole, such that at least one of the lateral protrusion and the hole must elastically deform to allow the lateral protrusion to pass through the hole.

27. The reusable cooking bag of claim 26, wherein the at least one lateral protrusion comprises a plurality of lateral protrusions located along the longitudinal axis.

28. The reusable cooking bag of claim 26, wherein the first panel, second panel, seam, strap and clasp are comprise a single molded part.

29. The reusable cooking bag of claim 28, wherein the single molded part comprises a silicone material.

30. The reusable cooking bag of claim 26, further comprising at least one preformed folding seam comprising a line of reduced thickness of at least one of the first panel and the second panel, the at least one folding seam extending along a direction of the opening and spaced from the opening to provide a discrete location at which the first panel and the second panel can be folded.
